(19) United States
(12) Patent Application Publication
(10) Pub. No.: US 2025/0323250 A1
(43) Pub. Date: Oct. 16, 2025

(54) NEGATIVE ELECTRODE ACTIVE MATERIALS, PREPARATION METHODS THEREOF, NEGATIVE ELECTRODES, AND RECHARGEABLE LITHIUM BATTERIES INCLUDING SAME

(71) Applicant: SAMSUNG SDI CO., LTD., Yongin-si (KR)

(72) Inventors: Hee Seon CHOI, Yongin-si (KR); Changsu SHIN, Yongin-si (KR); Dae-Hyeok LEE, Yongin-si (KR); Soonbong CHOI, Yongin-si (KR); Minyeong SONG, Yongin-si (KR)

(73) Assignee: SAMSUNG SDI CO., LTD., Yongin-si (KR)

(21) Appl. No.: 19/174,257

(22) Filed: Apr. 9, 2025

(30) Foreign Application Priority Data
Apr. 12, 2024 (KR) 10-2024-0049628

(51) Int. Cl. H01M 4/36; H01M 4/02; H01M 4/133; H01M 4/134; H01M 4/38; H01M 4/583; H01M 10/052

(52) U.S. Cl. CPC H01M 4/366; H01M 4/133; H01M 4/134; H01M 4/364; H01M 4/386; H01M 4/583; H01M 10/052; H01M 2004/021; H01M 2004/027

(57) ABSTRACT

Examples of the disclosure include a negative electrode active material including a spherical core including silicon nanoparticles and sulfur, and an amorphous carbon coating layer on the surface of the spherical core, wherein the negative electrode active material has a span value in a range of about 1.1 to about 1.6, and exhibiting high efficiency, high capacity, and long cycle-life characteristics.

### CROSS-REFERENCE TO RELATED APPLICATION

This application claims the benefit of priority to Korean Patent Application No. 10-2024-0049628 filed in the Korean Intellectual Property Office on Apr. 12, 2024, the entire contents of which are incorporated herein by reference.

### BACKGROUND OF THE DISCLOSURE

### (a) Field of the Disclosure

Negative electrode active materials, preparation methods thereof, and negative electrode and rechargeable lithium batteries including the negative electrode active materials are disclosed.

### (b) Description of the Related Art

Rechargeable lithium batteries typically have high electrochemical capacity and operating potential, and desired or improved charge/discharge cycle characteristics, and thus rechargeable lithium batteries are widely included in, e.g., portable information terminals, portable electronic devices, small household power storage devices, motorcycles, electric vehicles, hybrid electric vehicles, and the like. With the spread of rechargeable lithium batteries, there is demand for improved safety and higher performance.

An example of a method of increasing the capacity of a rechargeable lithium battery includes using a silicon-containing active material for the negative electrode. When an active material including silicon, which has a greater amount of lithium intercalation/deintercalation than conventional carbon-based active materials, is applied to the negative electrode, improvement in battery capacity may be expected. However, because silicon-based active materials typically have a large volume change accompanying lithium intercalation/deintercalation, the negative electrode active material layer may expand and contract violently during charging and discharging, which may present a challenge. In order to address this challenge, it may be advantageous to change the structure or composition of silicon-based negative electrode active materials. However, there may be limitations such as difficulty in practical application, cycle-life characteristics not being improved, and electrode expansion not being sufficiently reduced or suppressed.

### SUMMARY OF THE DISCLOSURE

Some example embodiments include a negative electrode active material that exhibits improved expansion properties and desired or improved cycle-life properties.

Some example embodiments include a negative electrode and a rechargeable lithium battery including the negative electrode active material.

According to some example embodiments, a negative electrode active material includes a spherical core including silicon nanoparticles and sulfur, and an amorphous carbon coating layer on the surface of the core, wherein the negative electrode active material has a span value, which is the standard deviation around the mean value, determined according to Equation 1 below, in a range of about 1.1 to about 1.6.

$$Span = ( D 90 - D 10 ) / D 50 \qquad Equation 1$$

In Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution.

According to some example embodiments, a method of preparing a negative electrode active material includes (i) pulverizing silicon to produce nano-sized silicon particles, (ii) preparing a composition including the silicon particles, a sulfur precursor, and ethanol, (iii) spray drying the composition to produce a dried product, and (iv) forming an amorphous carbon coating layer using the dried product and an amorphous carbon precursor, wherein the negative electrode active material has a span value according to Equation 1 below that is in a range of about 1.1 to about 1.6.

$$Span = ( D 90 - D 10 ) / D 50 \qquad Equation 1$$

In Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution.

According to some example embodiments, a negative electrode includes a negative electrode current collector, and a negative electrode active material layer on the negative electrode current collector, wherein the negative electrode active material layer includes the negative electrode active material.

According to some example embodiments, a rechargeable lithium battery includes the negative electrode, a positive electrode, and an electrolyte.

The negative electrode active material according to some example embodiments may exhibit high efficiency, high capacity, and long cycle-life characteristics.

### BRIEF DESCRIPTION OF THE DRAWINGS

FIGS. 1 to 4 are schematic views illustrating a rechargeable lithium battery, according to some example embodiments.

FIG. 5 is a flow chart illustrating a method of preparing a negative electrode active material, according to example embodiments.

### DETAILED DESCRIPTION

Hereinafter, example embodiments are described in detail so that those of ordinary skill in the art can readily implement the example embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but these terms do not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It is understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

Herein, “or” is not to be construed as an exclusive meaning, for example, “A or B” is construed to include A, B, A+B, and the like.

As used herein, when a definition is not otherwise provided, the particle diameter or size may be an average particle diameter. This average particle diameter refers to an average value of the particle size diameter according to the cumulative volume in the particle size distribution of particles included in the negative electrode active material. The particle distribution may be measured by a method well known to those skilled in the art, for example, by a particle size analyzer, or by a transmission electron microscope image or a scanning electron microscope image. Alternatively, it is possible to obtain an average particle diameter value by measuring using a dynamic light scattering method, performing data analysis, counting the number of particles for each particle size range, and calculating from this.

Soft carbon refers to a carbon material that can be graphitized, and is a material that is readily graphitized by heat treatment at a high temperature, for example, about 2800° C. Hard carbon is a carbon material that cannot be graphitized or is finely graphitized by heat treatment.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Negative Electrode Active Material

In some example embodiments, a negative electrode active material for a rechargeable lithium battery includes a spherical core including silicon nanoparticles and sulfur, and an amorphous carbon coating layer on the surface of the core, wherein the negative electrode active material has a span value as defined in Equation 1 in a range of about 1.1 to about 1.6.

$$Span = ( D 90 - D 10 ) / D 50 \qquad Equation 1$$

In Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution.

The negative electrode active material according to some example embodiments includes silicon nanoparticles in the core. The theoretical capacity of graphite included in the negative electrode of a general rechargeable lithium battery is limited to about 372 mAh/g, and the negative electrode active material according to some example embodiments includes silicon nanoparticles with a theoretical capacity of about 4,200 mAh/g to overcome the limitation on the graphite in the negative electrode. The silicon nanoparticles may exist as silicon nanoparticles themselves, or in a partially oxidized form, and in this case, the atomic content ratio of Si:O, which indicates the degree of oxidation, may be in a range of about 99:1 to about 34:66 by weight. That is, the silicon nanoparticles may be Si or SiOₓ, and in this case, the range of x in SiOₓ may be greater than about 0 and less than about 2.

The negative electrode active material according to some example embodiments includes sulfur as well as silicon nanoparticles in the core. The sulfur has strong nucleophilicity, and thus may cause a nucleophilic reaction with vinylene carbonate and/or fluoroethylene carbonate, which are included as additives in the electrolyte solution, to form an artificial SEI film in situ on the surface of the silicon particle, and furthermore, sulfur protects the surface of silicon nanoparticles and blocks the electrolyte from destroying the negative electrode active material, thereby improving energy density and extending cycle-life. In addition, the inclusion of sulfur in the core improves ion and electron transfer performance, thereby improving electrical conductivity, which has the advantage of enabling rapid charging.

In some example embodiments, a weight of sulfur based on a total weight of the core may be in the range of about 20 ppm to about 200 ppm, for example, about 50 ppm to about 200 ppm, about 90 ppm to about 200 ppm, about 90 ppm to about 150 ppm, or about 90 ppm to about 120 ppm. When the sulfur content satisfies any of the above ranges, the cycle-life can be extended by protecting the surface of the silicon nanoparticle and blocking the destruction of the electrolyte to the negative electrode active material, and the ion or electron transfer performance is improved, which has the advantage of improving electrical conductivity.

In some example embodiments, an average particle diameter (D50) of sulfur may be in a range of about 5 nm to about 15 nm, for example, about 5 nm to about 12 nm, about 7 nm to about 12 nm, or about 7 nm to about 9 nm. When the average particle size of sulfur (D50) satisfies any of the above ranges, the cycle-life can be extended by protecting the surface of the silicon nanoparticle and blocking the destruction of the electrolyte to the negative electrode active material, and the ion or electron transfer performance is improved, thereby increasing electrical conductivity.

The core of the negative electrode active material according to some example embodiments is substantially spherical and has a spherical shape, so that the negative electrode active material can be sufficiently dispersed throughout the negative electrode, thereby reducing an expansion rate during charging and discharging. In addition, when the negative electrode active material is mixed with crystalline carbon, the substantially spherical negative electrode active material can be better inserted into the crystalline carbon, and thus can be better dispersed throughout the negative electrode.

The negative electrode active material according to some example embodiments has a span value in a range of about 1.1 to about 1.6, for example, about 1.1 to about 1.55, or about 1.1 to about 1.5 in Equation 1. When the span value of the negative electrode active material is within any of the above ranges, it means that the negative electrode active material contains virtually no fine powders. That is, the size is about 1 μm or less and generally includes little amorphous fine powder, so that the negative electrode active material can exhibit a low specific surface area, thereby reducing side reactions of an electrolyte solution and improving cycle-life.

$$Span = ( D 90 - D 10 ) / D 50 \qquad Equation 1$$

In Equation 1, D10 is a particle diameter of a negative electrode active material particle with a cumulative volume of 10 volume % in the particle size distribution, D50 is a particle diameter of a negative electrode active material particle with a cumulative volume of 50 volume % in the particle size distribution, and D90 is the particle diameter of a negative electrode active material particle with a cumulative volume of 90 volume % in the particle size distribution.

The negative electrode active material according to some example embodiments may have a sphericity(S) expressed by Equation 2 that is in a range of about 0.9 to about 1.0, for example, about 0.92 to about 0.98, or about 0.92 to about 0.95, which indicate that negative electrode active material is spherical, or substantially spherical. When the sphericity of the negative electrode active material is within any of the above ranges, the expansion rate during charging and discharging can be more effectively reduced or suppressed.

$$Sphericity ( S ) = 4 π \times A / {B}^{2} \qquad Equation 2$$

In Equation 2, A is an area of the negative electrode active material, and B is a circumferential length of the shape of the negative electrode active material.

Explaining the sphericity in more detail, the sphericity of the negative electrode active material may be obtained by projecting a three-dimensional particle onto a two-dimensional plane. For example, the sphericity may be a ratio of boundary of a circle with the same area as the area of an actual particle. Herein, the area, A, may be obtained by obtaining a scanning electron microscope (SEM) image of an electrode cross-section with CP-SEM (a controlled pressure scanning electron microscope), using the cross-section image to obtain a circumference B of an actual particle through the Image J program, and using the circumference B to find a circle with the same circumference as B and calculate an area of the circle. In some example embodiments, the actual circumference length may be a circumference of any particle having a non-perfect spherical shape, that is, an uneven region as well as a perfect spherical shape.

In some example embodiments, the spherical core may have an average particle diameter (D₅₀) in a range of about 10 nm to about 1000 nm, for example, about 10 nm to about 900 nm, about 10 nm to about 800 nm, about 10 nm to about 700 nm, about 10 nm to about 600 nm, about 10 nm to about 500 nm, about 10 nm to about 400 nm, or about 10 nm to about 300 nm. When the spherical core has an average particle diameter (D₅₀) within any of the above ranges, there may be advantages of reducing or suppressing a volume expansion generated during charging and discharging, and reducing or preventing a disconnection of a conductive path due to particle breakage during the charging and discharging. Herein, the average particle diameter (D₅₀) of spherical core may be obtained by measuring sizes of about 20 particles randomly selected from the scanning electron microscope image (measuring a diameter of a circular particle but a length of a major axis of a non-circular particle) to obtain a particle size distribution, and taking a diameter of a particle with a cumulative volume of 50 volume % from the particle size distribution as the average particle diameter.

The negative electrode active material according to some example embodiments may include an amorphous carbon coating layer located on the core surface. In the amorphous carbon coating layer, the amorphous carbon may be or include soft carbon or hard carbon, mesophase pitch carbonized product, fired coke, or a combination thereof. The amorphous carbon coating layer may have a thickness in a range of about 1 nm to about 2 μm, for example, about 1 nm to about 500 nm, about 10 nm to about 300 nm, or about 20 nm to about 200 nm. When the amorphous carbon coating layer has a thickness within the ranges, the silicon volume expansion during the charging and discharging may be substantially reduced or suppressed.

In some example embodiments, a content of the core may be in a range of about 55 wt % to about 64 wt % based on 100 wt % of the total negative electrode active material, for example, about 56 wt % to about 63 wt %, or about 58 wt % to about 62 wt %. In addition, the content of the amorphous carbon coating layer may be in a range of about 36 wt % to about 45 wt % based on 100 wt % of the total negative electrode active material, for example, about 37 wt % to about 43 wt %, or about 36 wt % to about 45 wt %. When the contents of the core and the amorphous carbon coating layer respectively satisfy any of the above ranges, the excessive volume expansion generated during the charging and discharging may be reduced or suppressed, and the disconnection of a conductive path due to particle breakage during the charging and discharging may be reduced or prevented.

### Method of Preparing Negative Electrode Active Material

A method of preparing a negative electrode active material according to some example embodiments includes (i) pulverizing silicon to produce nano-sized silicon particles; (ii) preparing a composition including the silicon particles, a sulfur precursor, and ethanol; (iii) spray drying the composition to produce a dried product; and (iv) forming an amorphous carbon coating layer using the dried product and an amorphous carbon precursor, wherein the negative electrode active material has a span value according to Equation 1 in a range of about 1.1 to about 1.6.

$$Span = ( D 90 - D 10 ) / D 50 \qquad Equation 1$$

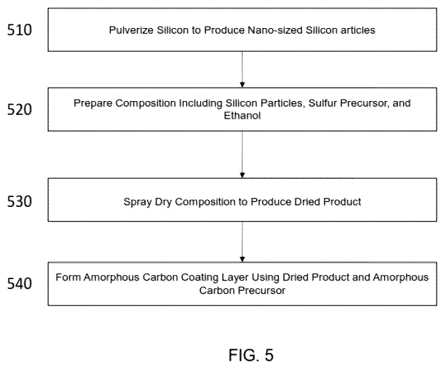

In Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution. Further description of the method of preparing the negative electrode active material is provided below with respect to FIG. 5.

In some example embodiments, nano-sized silicon particles are produced by pulverizing micrometer-sized silicon. The pulverizing process can be performed with ball milling, and the like conventional process. In the pulverizing process, a dispersant can be used. The dispersant may be or include at least one of stearic acid, boron nitride (BN), MgS, polyvinylpyrrolidone (PVP), or a combination thereof. There is no need to limit an amount of the dispersant because it is sufficient to use an appropriate amount for the milling process of silicon particles to occur. An average particle diameter (D₅₀) of the primary silicon particles may be in a range of about 10 nm to about 1000 nm, for example, about 10 nm to about 900 nm, about 10 nm to about 800 nm, about 10 nm to about 700 nm, about 10 nm to about 600 nm, about 10 nm to about 500 nm, about 10 nm to about 400 nm, or about 10 nm to about 300 nm.

In some example embodiments, a composition including the silicon particles, a sulfur precursor, and ethanol is prepared. Sulfate or polysulfide can be included as the sulfur precursor. A weight ratio of the silicon particles and the sulfur precursor may be in a range of about 2:1 to about 20:1, for example, about 2:1 to about 17:1, about 5:1 to about 17:1, about 5:1 to about 14:1, about 8:1 to about 14:1, or about 11:1 to about 14:1. When the weight ratio of silicon particles and sulfur precursor satisfies any of the above ranges, the cycle-life can be extended by protecting the surface of the silicon nanoparticles and blocking the destruction of the electrolyte to the negative electrode active material, and the ion or electron transfer performance is improved, thereby increasing electrical conductivity.

In some example embodiments, the composition including the silicon particles, a sulfur precursor, and ethanol is dried to produce a dry product. This drying process can be carried out as a spray drying process. By performing the drying process as a spray drying process, a dried product with more uniform particle size and spherical particles can be formed. When the dried product is a spherical particle with a uniform particle size, the amorphous carbon layer formed thereafter can be formed more uniformly on substantially the entire surface.

In some example embodiments, an amorphous carbon coating layer is formed using the dried product and an amorphous carbon precursor. The amorphous carbon precursor may be or include at least one of petroleum-based coke, coal-based coke, petroleum-based pitch, coal-based pitch, green coke, or a combination thereof.

In some example embodiments, in the forming of the amorphous carbon coating layer using the dried product and the amorphous carbon precursor, compression molding of the mixture of the dried product and the amorphous carbon precursor may be performed. The compression molding process can reduce pores inside the negative electrode active material, effectively reducing or suppressing side reactions. The compression molding process may be performed at a pressure that is sufficient to maintain the substantially spherical shape of the obtained product or, e.g., the final product, the negative electrode active material, and may be for example, performed at a pressure that is greater than about 0 MPa and less than or equal to about 30 MPa, greater than about 0 MPa and less than or equal to about 200 MPa, or in a range of about 5 MPa to about 20 MPa. The compression molding process can be performed by, e.g., cold isostatic pressing (CIP). When the compression molding is performed under the above pressure range, pores can be appropriately reduced while maintaining a substantially spherical shape without generating fine powders.

After performing the compression molding, the obtained compression molded product can be carbonized. The carbonization process may be performed at a temperature in a range of about 600° C. to about 1,000° C., may be performed in an N₂ atmosphere, a helium atmosphere, or a combination thereof, and the dispersant may be removed in the carbonization process. In addition, according to the carbonization process, the amorphous carbon precursor is converted to amorphous carbon and is formed to surround the surface of the compression molded product as an amorphous carbon coating layer. When the carbonization process is performed at the above temperature range, the problem of excessive growth of silicon particles can be reduced or suppressed, SiC formation can be reduced or suppressed, and the electrical conductivity of amorphous carbon can be improved. Additionally, some of the amorphous carbon may be inserted into pores formed between silicon particles, located on the surface of the silicon particle, and surrounded by the surface of the silicon particle. When the atmosphere of the carbonization process is included in the above conditions, amorphous carbon can be effectively formed while reducing or suppressing the oxidation of silicon and the production of SiC, thereby reducing the active material resistance.

Instead of the mixing process of the dried product and the amorphous carbon precursor, a vapor phase coating process using an amorphous carbon precursor gas may be performed on the dried product. In this case, an amorphous carbon coating layer can be formed on the surface of the product without a separate carbonization process. Therefore, after performing the vapor phase coating process, the compression molding process can be performed. The conditions of the compression molding process may be as described above.

Subsequently, a sieving process for the heat-treated product may be performed. The sieving process can be performed using a sieve so that the span value (defined by Equation 1) of the negative electrode active material may be in a range of about 1.1 to about 1.6. For example, the sieving process can be performed to obtain an active material having a particle size such that the span value obtained from D10, D50, and D90 of the active material may be in a range of about 1.1 to about 1.6.

FIG. 5 is a flow chart illustrating a method of preparing a negative electrode active material, according to example embodiments. For example, the method 500 includes operation 510, which includes pulverizing silicon to produce nano-sized silicon particles. Operation 520 includes preparing a composition including the pulverized silicon particles, a sulfur precursor, and ethanol. For example, the sulfur precursor includes one of sulfate and polysulfide. In another example, a weight ratio of the silicon particles and the sulfur precursor is in a range of about 2:1 to about 20:1. Operation 530 includes spray drying the composition to produce a dried product. Operation 540 includes forming an amorphous carbon coating layer using the dried product and an amorphous carbon precursor. In examples, the negative electrode active material has a span value as defined in Equation 1 in a range of about 1.1 to about 1.6:

$$Span = ( D 90 - D 10 ) / D 50 \qquad Equation 1$$

In examples, in Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution.

### Negative Electrode

The negative electrode for a rechargeable lithium battery includes a negative electrode current collector, and a negative electrode active material layer on the negative electrode current collector. The negative electrode active material layer includes the aforementioned negative electrode active material, may optionally further include another type of negative electrode active material, and may further include a binder and/or a conductive material.

For example, the negative electrode according to some example embodiments may include the aforementioned negative electrode active material as a first negative electrode active material, and may include a second negative electrode active material including crystalline carbon. Herein, the second negative electrode active material may be included in an amount in a range of about 1 wt % to about 60 wt %, or about 1 wt % to about 50 wt %, about 3 wt % to about 30 wt %, or about 3 wt % to about 10 wt % based on a total of 100 wt % of the first negative electrode active material and the second negative electrode active material, and may be appropriately mixed depending on the desired capacity.

### Binder

The binder is configured to adhere the negative electrode active material particles to each other, and also to adhere the negative electrode active material to the current collector. The binder may be a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include at least one of a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is included as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed. The alkali metal may be or include at least one of Na, K, or Li.

The dry binder may be or include a polymer material capable of becoming fiber, and may be or include, for example, at least one of polytetrafluoroethylene, polyvinylidene fluoride, a polyvinylidene fluoride-hexafluoropropylene copolymer, polyethylene oxide, or a combination thereof.

### Conductive Material

The conductive material may be included to provide electrode conductivity, and any electrically conductive material may be included as a conductive material unless the electrically conductive material causes a chemical change in or to the battery. Examples of the conductive material include a carbon-based material such as or including at least one of natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

### Negative Electrode Current Collector

The negative electrode current collector may be or include at least one of copper foil, nickel foil, stainless steel foil, titanium foil, nickel foam, copper foam, a polymer substrate coated with a conductive metal, and a combination thereof.

### Rechargeable Lithium Battery

In some example embodiments, a rechargeable lithium battery includes the aforementioned negative electrode, a positive electrode, and an electrolyte. Herein, the electrolyte may be or include liquid electrolyte or solid electrolyte.

For example, some example embodiments may include a rechargeable lithium battery including the aforementioned negative electrode, a positive electrode, a separator between the negative electrode and the positive electrode, and an electrolyte solution. Some example embodiments include an all-solid-state rechargeable lithium battery including the aforementioned negative electrode, positive electrode, and a solid electrolyte layer between the negative electrode and the positive electrode.

Hereinafter, a rechargeable lithium battery using an electrolyte solution is described as an example.

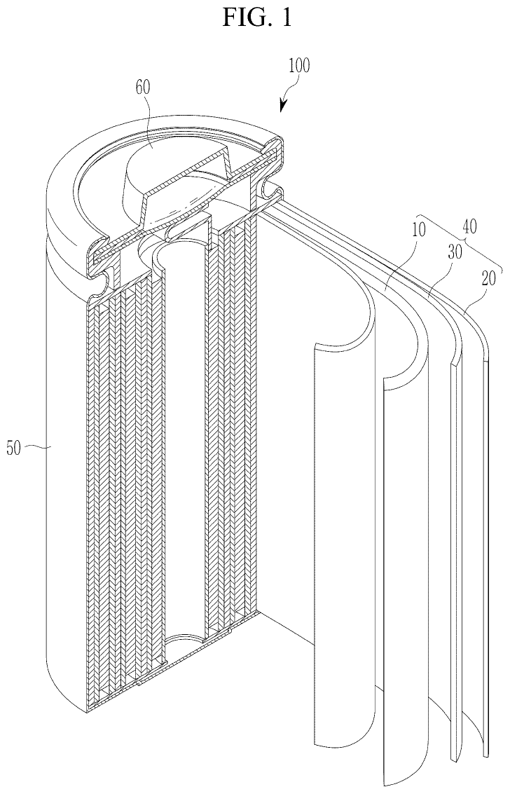

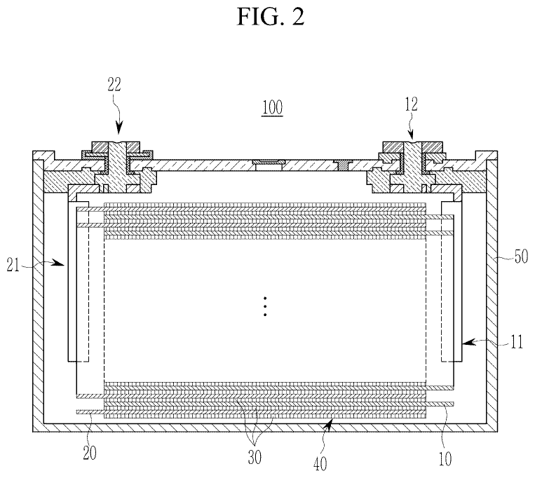

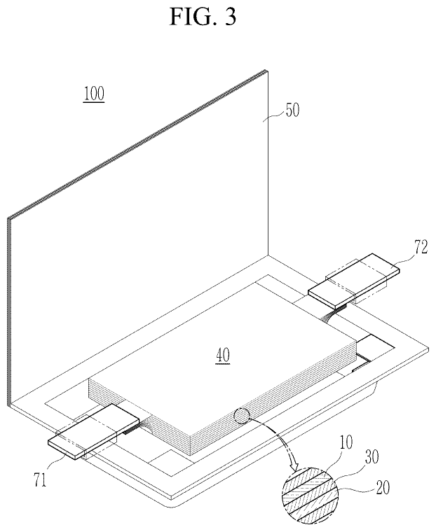

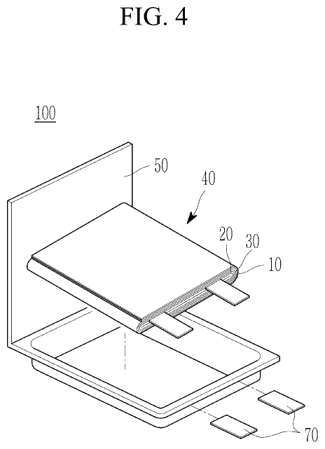

The rechargeable lithium battery may be classified into cylindrical, prismatic, pouch, coin, and the like, depending on the shape. FIGS. 1 to 4 are schematic diagrams illustrating the rechargeable lithium battery according to some example embodiments, where FIG. 1 illustrates a cylindrical battery, FIG. 2 illustrates a prismatic battery, and FIGS. 3 and 4 illustrate a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50 as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electrical path for inducing the current formed in the electrode assembly 40 to the outside of the battery 100.

### Positive Electrode

The positive electrode may include a positive electrode current collector, and a positive electrode active material layer on the positive electrode current collector. The positive electrode active material layer includes a positive electrode active material, and may further include a binder and/or a conductive material.

The positive electrode active material may be or include a compound capable of intercalating and deintercalating lithium (lithiated intercalation compound). For example, one or more types of composite oxides of a metal such as or including at least one of cobalt, manganese, nickel, and a combination thereof and lithium, may be used.

The composite oxide may be or include a lithium transition metal composite oxide, and examples thereof may include at least one of lithium nickel-based oxide, lithium cobalt-based oxide, lithium manganese-based oxide, a lithium iron phosphate-based compound, cobalt-free lithium nickel-manganese-based oxide, or a combination thereof.

As an example, a compound represented by any of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≥0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)} Fe₂ (PO₄)₃ (0≤f≤2); and LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L₁ is or includes at least one of Mn, Al, or a combination thereof.

As an example, the positive electrode active material may be or include a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol %, and less than or equal to 99 mol % based on 100 mol % of a metal excluding lithium in the lithium transition metal composite oxide. The high-nickel-based positive electrode active materials can achieve high capacity, and can be applied to high-capacity, high-density rechargeable lithium batteries.

An amount of the positive electrode active material may be in a range of about 90 wt % to about 98 wt %, for example, about 90 wt % to about 95 wt %, based on a total weight of the positive electrode active material layer. The amount of the binder and/or of the conductive material may be in a range of about 1 wt % to about 5 wt % based on a total weight of the positive electrode active material layer.

The binder is configured to improve the binding properties of positive electrode active material particles with one another and with a current collector, and examples thereof may include at least one of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is configured to provide electrode conductivity, and any electrically conductive material may be included as a conductive material unless the electrically conductive material causes a chemical change in or to the battery, and examples thereof may include a carbon-based material such as or including at least one of natural graphite, artificial graphite, carbon black, acetylene black, ketjen black, a carbon fiber, a carbon nanotube, and the like; a metal-based material of a metal powder or a metal fiber including copper, nickel, aluminum, silver, and the like; a conductive polymer such as a polyphenylene derivative; or a mixture thereof.

Aluminum foil may be included as the positive electrode current collector, but the positive electrode current collector is not limited thereto.

### Electrolyte Solution

The electrolyte solution may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone, and the like. The alcohol-based solvent may include at least one of ethanol, isopropyl alcohol, and the like, and the aprotic solvent may include at least one of nitriles such as R—CN (wherein R is a C2 to C20 linear, branched, or cyclic hydrocarbon group, a double bond, an aromatic ring, or an ether group, and the like); amides such as dimethylformamide; dioxolanes such as 1,3-dioxolane, 1,4-dioxolane, and the like; sulfolanes, and the like.

The non-aqueous organic solvents can be used alone or in a combination of two or more solvents.

When using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent is configured to supply lithium ions in a battery, to enable a basic operation of a rechargeable lithium battery, and to improve transportation of the lithium ions between positive and negative electrodes. Examples of the lithium salt may include at least one of LiPF₆, LiBF₄, LiSbF₆, LiAsF₆, LiClO₄, LiAlO₂, LiAlCl₄, LiPO₂F₂, LiCl, LiI, LIN (SO₃C₂F₅)₂, Li(FSO₂)₂N (lithium bis(fluorosulfonyl)imide; LiFSI), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethane sulfonate, lithium difluorobis(oxalato) phosphate (LiDFBOP), and lithium bis(oxalato) borate (LiBOB).

### Separator

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include at least a polyvinylidene fluoride-based polymer or a (meth)acrylic-based polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked.

Examples and comparative examples of the present disclosure are described below. However, the following examples are only examples of the present disclosure, and the present disclosure is not limited to the following examples.

### Example 1

Silicon particles with an average particle diameter of 8 μm were mixed with stearic acid, and were ball-milled into primary silicon particles with an average particle diameter (D₅₀) of 100 nm, and the primary silicon particles were mixed with polysulfide to prepare a mixture. The mixture was mixed with ethanol, and spray-dried to prepare secondary particles having an average particle diameter (D₅₀) of 7 μm and including pores, wherein a weight ratio of the sulfur to the secondary particles was designed to be 50 ppm.

The prepared secondary particles were mixed with petroleum pitch in a weight ratio of 60:40, and compression-molded at a pressure of 10 Mpa in a cold isostatic pressing method. Subsequently, The compression-molded product was carbonized under an N₂ atmosphere at 1,000° C.

Subsequently, the carbonized product was sieved to have 1.1 of a span of Equation 1 with a sieve, preparing a silicon-carbon composite having secondary particles with an average particle diameter (D₅₀) of 7 μm, in which primary silicon particles with an average particle diameter (D₅₀) of 100 nm, and a 30 nm-thick carbon coating layer on the secondary particles, as a negative electrode active material. Herein, a content of the secondary particle was 60 wt % based on a total weight of the negative electrode active material, and a content of the amorphous carbon was 40 wt %. In addition, the negative electrode active material was analyzed with respect to D₁₀, D₅₀, and D₉₀ by using a particle size analyzer (Trade name: LS 13 320, Manufacturer: Beckman Coulter Inc.), and the results are shown in Table 1 below.

In addition, when a cross-section image thereof taken with CP-SEM was analyzed through Image J program, from which sphericity of 0.98 was obtained.

The manufactured negative electrode active material as a first negative electrode active material was mixed with natural graphite as a second negative electrode active material in a weight ratio of 90:10, and 97.5 wt % of the mixed negative electrode active material, 1.5 wt % of carboxylmethyl cellulose, and 1 wt % of a styrene butadiene rubber were mixed in a water solvent, preparing negative electrode active material layer slurry.

The negative electrode active material layer slurry was coated on a Cu foil current collector, and subsequently dried and compressed to form a negative electrode active material layer, manufacturing a negative electrode.

The negative electrode was used with a lithium metal counter electrode and an electrolyte solution, manufacturing a half-cell in a common method. The electrolyte solution was prepared by dissolving 1 M LiPF₆ in a mixed solvent of ethylene carbonate and dimethyl carbonate (in a volume ratio of 3:7).

In addition, a positive electrode was manufactured by mixing 96 wt % of a LiNi_{0.88}Co_{0.11}Al_{0.01}O₂ as a positive electrode active material, 2 wt % of polyvinylidene fluoride as a binder, and 2 wt % of Ketjen black as a conductive material in an N-methyl pyrrolidone solvent to prepare positive electrode active material layer slurry and coating the positive electrode active material layer slurry on an Al foil current collector, and subsequently drying and compressing the positive electrode active material layer slurry to form a positive electrode active material layer.

The negative and positive electrodes were used with an electrolyte solution to manufacture a coin-type full cell and a pouch-type full cell in a common method. The electrolyte solution was prepared by dissolving 1 M LiPF₆ in a mixed solvent of ethylene carbonate and dimethyl carbonate (in a volume ratio of 3:7).

### Example 2

A negative electrode, a half-cell, a coin-type full cell, and a pouch-type full cell were manufactured substantially in the same manner as in Example 1, with a difference that a negative electrode active material having a span of 1.5 and sphericity of 0.92 was prepared by designing the weight ratio of the sulfur and the secondary particles to be 100 ppm and performing the sieving process so that the span of Equation 1 might be 1.5.

### Example 3

A negative electrode, a half-cell, a coin-type full cell, and a pouch-type full cell were manufactured substantially in the same manner as in Example 1, with a difference that a negative electrode active material having sphericity of 0.95 was prepared by designing the weight ratio of the sulfur to that of the secondary particles to be 150 ppm and performing the sieving process so that the span of Equation 1 might be 1.3.

### Comparative Example 1

A negative electrode, a half-cell, a coin-type full cell, and a pouch-type full cell were manufactured substantially in the same manner as in Example 1, with a difference that a negative electrode active material having sphericity of 0.95 was prepared by performing the sieving process so that the span of Equation 1 might be 1.0 without performing the compression molding process of the mixture of the secondary particles and the petroleum pitch.

### Comparative Example 2

A negative electrode, a half-cell, a coin-type full cell, and a pouch-type full cell were manufactured substantially in the same manner as in Example 1, with a difference that a negative electrode active material having sphericity of 0.95 was prepared by performing the sieving process so that the span of Equation 1 might be 1.7 and cold isostatic pressing the mixture of the secondary particles and the petroleum pitch at a pressure of 35 Mpa.

### Comparative Example 3

A negative electrode, a half-cell, a coin-type full cell, and a pouch-type full cell were manufactured substantially in the same manner as in Example 1, with a difference that a negative electrode active material having sphericity of 0.85, that is, having no spherical shape, was prepared by performing the sieving process so that the span of Equation 1 might be 1.1 and cold isostatic pressing the mixture of the secondary particles and petroleum pitch at a pressure of 150 Mpa.

### Comparative Example 4

A negative electrode, a half-cell, a coin-type full cell, and a pouch-type full cell were manufactured substantially in the same manner as in Example 1, with a difference that a negative electrode active material having sphericity of 0.85, that is, having no spherical shape was prepared by performing the sieving process so that the span of Equation 1 might be 1.5 and cold isostatic pressing the mixture of the secondary particles and the petroleum pitch at a pressure of 150 Mpa.

### Comparative Example 5

A negative electrode, a half-cell, a coin-type full cell, and a pouch-type full cell were manufactured substantially in the same manner as in Example 1, with a difference that the core was manufactured by not using the polysulfide.

### Comparative Example 6

A negative electrode, a half-cell, a coin-type full cell, and a pouch-type full cell were manufactured substantially in the same manner as in Example 1, with a difference that the weight ratio of the sulfur to the secondary particles was designed to be 300 ppm.

In order to facilitate understanding, the negative electrode active material designs of the examples and the comparative examples are briefly shown in Table 1 below.

TABLE 1

| | Weight of sulfur based | | | |
|---|---|---|---|---|
| | on particle weight | | Sphericity | Span |
| Ex. 1 | 50 | ppm | 0.98 | 1.1 |
| Ex. 2 | 100 | ppm | 0.92 | 1.5 |
| Ex. 3 | 150 | ppm | 0.95 | 1.3 |
| Comp. Ex. 1 | 50 | ppm | 0.95 | 1.0 |
| Comp. Ex. 2 | 50 | ppm | 0.95 | 1.7 |
| Comp. Ex. 3 | 50 | ppm | 0.85 | 1.1 |
| Comp. Ex. 4 | 50 | ppm | 0.85 | 1.5 |
| Comp. Ex. 5 | 0 | ppm | 0.98 | 1.1 |
| Comp. Ex. 6 | 300 | ppm | 0.98 | 1.1 |

### Evaluation Example 1: Evaluation of Charging and Discharging Efficiency

The half-cells according to Examples 1 to 3 and Comparative Examples 1 to 6 were charged and discharged once within a range of 0.01 V to 1.5 V at 0.1 C to measure charge capacity and discharge capacity, and calculate a ratio of the charge capacity and the discharge capacity, and the results are shown as a charging rate in Table 2.

### Evaluation Example 2: Evaluation of Cycle-Life Characteristics

The coin-type full battery cells according to Examples 1 to 3 and Comparative Examples 1 to 6 were charged and discharged once at 0.1 C, once at 0.2 C, and then 500 times at 1 C within a range of 2.5 V to 4.2 V. After the first charge/discharge cycle, the initial DC-IR (direct current internal resistance) was measured and shown in Table 2 below. The charge and discharge and cut-off conditions are as follows.

Charge: constant current-constant voltage, 4.2 V/0.01 C cut-off

Discharge: constant voltage, 2.5 V cut-off

A ratio of discharge capacity at the 500^{th} cycle to discharge capacity at the 1^{st} was calculated, and the results are shown as a cycle-life in Table 2 below.

### Evaluation Example 3: Evaluation of Expansion Properties

The pouch-type full battery cells according to Examples 1 to 3 and Comparative Examples 1 to 6 were charged and discharged once at 0.1 C for formation, and then charged and discharged 25 times at 1 C. A ratio of a battery thickness at the 25^{th} charge and discharge to a battery thickness after the formation charge and discharge was calculated, and the results are provided as an expansion rate in Table 2 below.

Charge: constant current-constant voltage, 4.2 V/0.01 C cut-off

Discharge: constant voltage, 2.5 V cut-off

Additionally, the negative active materials according to Examples 1 to 3 and Comparative Examples 1 to 6 were pulverized, collected, and the powder conductivity of the negative active materials was measured using a powder resistor.

TABLE 2

| | Powder | | Charging | Expansion | Cycle- |
|---|---|---|---|---|---|
| | conductivity | | rate | rate | life |
| | (Ω · cm) | DC-IR | (%) | (%) | (%) |
| Example 1 | 0.24 | 5.8 | 34 | 17 | 86 |
| Example 2 | 0.21 | 5.4 | 37 | 14 | 90 |
| Example 3 | 0.18 | 5.2 | 38 | 16 | 88 |
| Comparative | 0.26 | 6.0 | 33 | 19 | 83 |
| Example 1 | | | | | |
| Comparative | 0.29 | 6.2 | 30 | 22 | 81 |
| Example 2 | | | | | |
| Comparative | 0.32 | 6.5 | 28 | 23 | 78 |
| Example 3 | | | | | |
| Comparative | 0.33 | 6.6 | 29 | 24 | 75 |
| Example 4 | | | | | |
| Comparative | 0.28 | 6.5 | 31 | 22 | 82 |
| Example 5 | | | | | |
| Comparative | 0.35 | 6.8 | 25 | 27 | 70 |
| Example 6 | | | | | |

Referring to Table 2, compared to Comparative Examples 1 and 2 having a span according to Equation 1 that is outside of the range of 1.1 to 1.6, Examples 1 to 3 having a span within the range of 1.1 to 1.6 exhibited improved cycle-life characteristics and reduced expansion rates.

In addition, compared with Comparative Examples 3 and 4 having a sphericity according to Equation 2 that is outside a range of 0.9 to 1.0, Examples 1 to 3 having a sphericity according to Equation 2 within the range of 0.9 to 1.0 exhibited improved cycle-life characteristics and a reduced expansion rate.

Furthermore, compared with Comparative Example 5 which include no sulfur in the negative electrode active material, Examples 1 to 3 including sulfur in the negative electrode active material exhibited desired or improved trends in powder conductivity, a charging rate, an expansion rate, and cycle-life characteristics.

In addition, compared with Comparative Example 6 having a weight ratio of the sulfur to the secondary particles that is outside of the range of 20 ppm to 200 ppm, Examples 1 to 3 having a weight ratio of the sulfur to the secondary particles within the range of 20 ppm to 200 ppm exhibited desired or improved trends in powder conductivity, DC-IR, a charging rate, an expansion rate, and cycle-life characteristics.

Although the example embodiments of the present disclosure have been described above, the present disclosure is not limited thereto, and can be implemented with various modifications within the scope of the claims, the detailed description of the disclosure, and the accompanying drawings, and these also fall within the scope of the present disclosure.

Description of Symbols:

| | | | |
|---|---|---|---|
| 100: | rechargeable lithium battery | 10: | positive electrode |
| 11: | positive electrode lead tab | 12: | positive terminal |
| 20: | negative electrode | 21: | negative electrode lead tab |
| 22: | negative electrode terminal | 30: | separator |
| 40: | electrode assembly | 50: | case |
| 60: | sealing member | 70: | electrode tab |
| 71: | positive electrode tab | 72: | negative electrode tab |

What is claimed is:

1. A negative electrode active material, comprising:
a spherical core comprising silicon nanoparticles and sulfur; and
an amorphous carbon coating layer on a surface of the spherical core,
wherein the negative electrode active material has a span value as defined in Equation 1 in a range of about 1.1 to about 1.6:
$$span = ( D 90 - D 10 ) / D 50 \qquad Equation 1$$
wherein, in Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution.

2. The negative electrode active material as claimed in claim 1, wherein a weight of sulfur based on a total weight of the spherical core is in a range of about 20 ppm to about 200 ppm.

3. The negative electrode active material as claimed in claim 1, wherein an average particle diameter (D50) of sulfur is in a range of about 5 nm to about 15 nm.

4. The negative electrode active material as claimed in claim 1, wherein the negative electrode active material has a span value in a range of about 1.1 to about 1.5.

5. The negative electrode active material as claimed in claim 1, wherein:
the negative electrode active material has a sphericity(S) according to Equation 2 in a range of about 0.9 to about 1.0:
$$Sphericity ( S ) = 4 π \times A / {B}^{2} \qquad Equation 2$$
wherein, in Equation 2, A is an area of the negative electrode active material, and B is a circumferential length of a shape of the negative electrode active material.

6. The negative electrode active material as claimed in claim 5, wherein the negative electrode active material has a sphericity in a range of about 0.92 to about 0.95.

7. The negative electrode active material as claimed in claim 1, wherein an average particle diameter (D50) of the spherical core is in a range of about 10 nm to about 1000 nm.

8. The negative electrode active material as claimed in claim 1, wherein the amorphous carbon coating layer has a thickness in a range of about 1 nm to about 2 μm.

9. The negative electrode active material as claimed in claim 1, wherein a content of the spherical core is in a range of about 55 wt % to about 64 wt % based on 100 wt % of the total negative electrode active material.

10. A method of preparing a negative electrode active material, the method comprising:
(i) pulverizing silicon to produce nano-sized silicon particles;
(ii) preparing a composition including the pulverized silicon particles, a sulfur precursor, and ethanol;
(iii) spray drying the composition to produce a dried product; and
(iv) forming an amorphous carbon coating layer using the dried product and an amorphous carbon precursor,
wherein the negative electrode active material has a span value as defined in Equation 1 in a range of about 1.1 to about 1.6:
$$Span = ( D 90 - D 10 ) / D 50 \qquad Equation 1$$
wherein, in Equation 1, D10 is a particle diameter of a particle with a cumulative volume of 10 volume % in the particle size distribution, D50 is a particle diameter of a particle with a cumulative volume of 50 volume % in the particle size distribution, and D90 is the particle diameter of a particle with a cumulative volume of 90 volume % in the particle size distribution.

11. The method as claimed in claim 10, wherein the sulfur precursor comprises at least one of sulfate and polysulfide.

12. The method as claimed in claim 10, wherein a weight ratio of the silicon particles and the sulfur precursor is in a range of about 2:1 to about 20:1.

13. A negative electrode, comprising:
a negative electrode current collector; and
a negative electrode active material layer on the negative electrode current collector,
wherein the negative electrode active material layer includes the negative electrode active material as claimed in claim 1.

14. A rechargeable lithium battery, comprising:
the negative electrode as claimed in claim 13;
a positive electrode; and
an electrolyte.
